(19) United States
(12) Patent Application Publication
(10) Pub. No.: US 2017/0076233 A1
(43) Pub. Date: Mar. 16, 2017

(54) Sharing Application for Equipment and Personnel

(71) Applicant: Caterpillar Inc., Peoria, IL (US)

(72) Inventors: Bart Finn, Peoria, IL (US); Lucinda Penner, Manhattan, KS (US); Stephanie Smith, Chicago, IL (US); Meghan McCormick, Villanova, PA (US); Willa Zhang, Chicago, IL (US); Elaine Meese, Chicago, IL (US)

(73) Assignee: Caterpillar Inc., Peoria, IL (US)

(21) Appl. No.: 14/854,653

(22) Filed: Sep. 15, 2015

(51) Int. Cl. G06Q 10/06; G06Q 50/08

(52) U.S. Cl. CPC G06Q 10/06313; G06Q 50/08

(57) ABSTRACT

A sharing application for equipment, materials, and/or personnel is disclosed. A method for obtaining use, by a recipient, of an asset made available by a supplier on an asset sharing platform may include receiving first data comprising one or more criteria associated with a desired asset and an indication of a planned usage of the desired asset, wherein the desired asset comprises one or more of a heavy machine, a heavy machine implement, and a service relating to heavy machines. Second data may be received comprising at least one of data associated with the recipient, data associated with a plurality of suppliers, and data associated with a plurality of available assets. The method may further include causing display of an asset listing comprising identifications of one or more assets of the plurality of available assets, the displayed asset listing determined based, at least, on the first data and the second data. An indication of a selected asset from the one or more assets of the displayed asset listing may be received.

### TECHNICAL FIELD

This disclosure relates generally to construction resource usage and more particularly to a sharing application for equipment, materials, and/or personnel.

### BACKGROUND

When an entity such as an individual or business involved with construction, mining, agriculture, logging, or the like, bids on a job, the entity may often own the heavy machines, tools, and other equipment needed to complete that job. In addition, the entity may maintain a cadre of personnel to operate and service the equipment owned by the entity. The number, type, and size of jobs in which the entity is involved may ebb and flow according to the cyclic nature of the industry. The entity may find that equipment owned by the entity sits idle while the entity waits to win a bid that will require such equipment. Similarly, personnel or other assets of the entity may go unused if, for example, no current jobs by the entity require the skills of the personnel. Since the entity has previously paid or is in the process of paying for the equipment and presently pays the salary of the personnel, allowing such assets to remain unused represents a financial drain on the operations of the entity. Yet, if the entity liquidates some or all equipment and personnel not currently being fully utilized, the entity may find in the future that it lacks the equipment or personnel capacity to bid on all the jobs that it may wish to undertake. Thus a entity may be presented with a conundrum in which it attempts to maximize its return on investment in equipment and personnel yet still maintain a capacity sufficiently robust to bid on and complete a wide assortment of jobs.

U.S. Publication No. 2007/0073594 to Schwartz (hereinafter “Schwartz”) purports to disclose a method and system for sharing a resource between an owner and another party (a “sharer”). The disclosed method includes providing a listing, via a computer interface, of resources made available by their respective owners. A sharer may review the listings of resources and select one of the resources. Having selected a resource, the sharer places a bid to use the resource. The method and system disclosed in Schwartz, however, are ill-suited to accommodate a sharer that is unsure of the best resource required for the contemplated job. Moreover, the method and system disclosed in Schwartz are unable to arrange ancillary services to the sharer based on the bid-for resource. These and other shortcomings are addressed in the present disclosure.

### SUMMARY

This disclosure relates to a sharing application for equipment and personnel. In an aspect, a method for obtaining use, by a recipient, of an asset made available by a supplier via an asset sharing platform may include receiving, by one or more processors, first data comprising one or more criteria associated with a desired asset and an indication of a planned usage of the desired asset, wherein the desired asset comprises one or more of a heavy machine, a heavy machine implement, and a service relating to heavy machines; receiving, by the one or more processors, second data comprising at least one of data associated with the recipient, data associated with a plurality of suppliers, and data associated with a plurality of available assets; causing, by the one or more processors, display of an asset listing comprising identifications of one or more assets of the plurality of available assets, the displayed asset listing determined based, at least, on the first data and the second data; and receiving, by the one or more processors, an indication of a selected asset from the one or more assets of the displayed asset listing.

In an aspect, a method for obtaining use, by a recipient, of an asset made available by a supplier via an asset sharing platform may include receiving, by one or more processors, first data comprising one or more criteria associated with a desired asset, wherein the desired asset comprises one or more of a heavy machine, a heavy machine implement, and a service relating to heavy machines; receiving, by the one or more processors, second data comprising at least one of data associated with the recipient, data associated with a plurality of suppliers, and data associated with a plurality of available assets; receiving, by the one or more processor, third data comprising data associated with a plurality of third-party support services; causing, by the one or more processors, display of an asset listing comprising identifications of one or more assets of the plurality of available assets, the displayed asset listing determined based, at least, on the first data and the second data; causing, by the one or more processors, display of a third-party support service listing comprising identifications of one or more third-party support services, the displayed third-party support service listing determined based, at least, on the third data and at least one of the first data and the second data; receiving, by the one or more processors, an indication of a selected asset from the one or more assets of the displayed asset listing; and receiving, by the one or more processors, an indication of a selected third-party support service from the one or more third-party support services of the displayed third-party support service listing.

In an aspect, a method for obtaining use, by a recipient, of an asset made available by a supplier via an asset sharing platform may include receiving, by one or more processors, first data comprising one or more criteria associated with a desired asset, wherein the desired asset comprises one or more of a heavy machine, a heavy machine implement, and a service relating to heavy machines; receiving, by the one or more processors, second data comprising an indication of a first region associated with the recipient, an indication of a second region associated with at least one supplier of a plurality of suppliers, and data associated with a plurality of available assets; causing, by the one or more processors, display of an asset listing comprising identifications of one or more assets of the plurality of available assets, the displayed asset listing determined based, at least, on the first data, the second data, and a determination that at least a portion of the first region comprises at least a portion of the second region; and receiving, by the one or more processors, an indication of a selected asset from the one or more assets of the displayed asset listing.

### BRIEF DESCRIPTION OF THE DRAWINGS

The following detailed description is better understood when read in conjunction with the appended drawings. For the purposes of illustration, examples are shown in the drawings; however, the subject matter is not limited to the specific elements and instrumentalities disclosed. In the drawings:

FIG. 1 illustrates a block diagram of an example environment in which a platform may operate in accordance with aspects of the disclosure.

FIG. 2 illustrates a block diagram of a platform in accordance with aspects of the disclosure.

FIG. 3 illustrates an example user interface in accordance with aspects of the disclosure.

FIG. 4 illustrates an example user interface in accordance with aspects of the disclosure.

FIG. 5 illustrates an example user interface in accordance with aspects of the disclosure.

FIG. 6 illustrates an example user interface in accordance with aspects of the disclosure.

FIG. 7 illustrates a block diagram of an example method in accordance with aspects of the disclosure.

FIG. 8 illustrates a block diagram of a computer system configured to implement the method of FIG. 7.

### DETAILED DESCRIPTION

The systems and methods disclosed herein may provide a platform through which various users may interact to exchange goods and services. As an example, a user such as an owner of an asset (e.g., heavy machine, tooling, materials, personnel service, etc.), may offer the asset for usage by another user in return for a rental fee or other consideration. Conversely, a user in need of an asset may use the platform to assist in selecting an asset most appropriate for a planned job and to arrange a usage agreement with the other user owning that asset. A user wishing to obtain use of an asset listed on the platform may provide a variety of criteria relating to the user, the desired asset, and/or the planned usage of the asset. For example, the user may specify that the user wishes to obtain use of a bulldozer, a date range in which the user requires the bulldozer, a price limit that the user is willing to pay, and a region in which the user is able to arrange transport for the bulldozer to a jobsite. Based on these criteria, the platform may determine and provide a listing of available bulldozers meeting the criteria. The user may select one of the bulldozers and arrange, via the platform, for payment to the bulldozer owner for the use of the bulldozer.

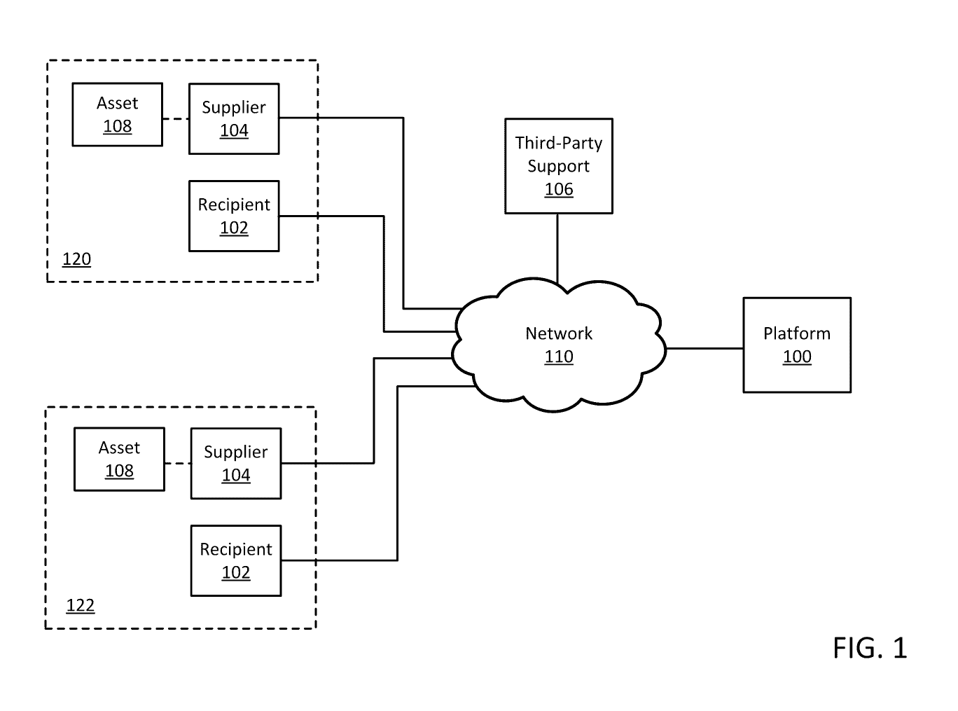

FIG. 1 depicts a block diagram of an example environment in which a platform 100 for sharing assets may be utilized. The term “asset” may refer to a physical asset, a service asset and/or a personnel asset. For example, a physical asset may include a heavy machine, equipment, tool, and/or material, and the like. A heavy machine asset may include any manner of heavy-duty vehicle used in any one of a variety of operations, such as excavation, earth-moving, logging, agriculture, mining, and/or construction. Specific types of heavy machines may include an excavator, a bulldozer, a vocational truck, a tractor, a grader, a skid steer loader, a hauling truck, a trencher, a backhoe loader, a front loader, a scraper, a compactor, a crane, a telescopic handler, and/or a roller. An equipment asset may include equipment relating to heavy machines, such as an engine or other part used in a heavy machine or an implement (e.g., bucket, hydraulic hammer, auger, grapple, or breaker) attachable to a heavy machine.

A service asset may include a service, such as a financial service, legal service, delivery service, repair service, jobsite solution service, or technical support service. A service asset may include a service relating to heavy machines, such as heavy machine repair service, heavy machine maintenance service, heavy machine operation service, heavy machine transportation service, and/or construction job bid preparation service. As yet another example, a personnel asset may refer to a personnel, such as heavy machine operator, a bid preparation specialist, or repair technician. A personnel asset may be associated with one or more service assets that the personnel asset may provide. For instance, the aforementioned heavy machine operator may provide hauling machine operation service or crane operation service.

The environment may include one or more recipients 102, one or more suppliers 104, and third-party support 106 which each may be connected to the platform 100 via a network 110. One or more of the suppliers 104 may each be associated with one or more assets 108.

The network 110 may include a wide area network (WAN), a local area network (LAN), the Internet, an intranet, a cellular network, a satellite network, or any other suitable network for transmitting data. The network 110 may be implemented as a wired network, a wireless network, or a combination thereof.

The platform 100, which will be discussed in further detail herein, may operate on a computing device, such as a server computer, or a series of connected computing devices. The platform 100 may be described as the software running on said computing device(s). The platform 100 may be embodied, in part, as a web interface, such as one or more web pages, accessible to the recipients 102, suppliers 104, third-party support 106, or other users over the network 110. The platform 100 may be embodied in a server-client configuration in which the recipients 102, suppliers 104, third-party support 106, or other users may utilize a local software client (e.g., a smartphone application) portion of the platform 100 to connect, via the network 110, to a remote server portion of the platform 100.

One or more suppliers 104 may connect to the platform 100 and each list one or more assets 108 associated with the supplier 104 as available for use. As used herein, the supplier 104 may refer to any type of entity, such as an individual person or a company, firm, or other organization. It is contemplated that the supplier 104 may include an individual or organization involved in the construction industry or other industry using heavy machinery, equipment, and tools. As an example, the supplier 104 may be a road-building company and may own a variety of assets 108, such as a grader, hauling machine, and road roller. As such, the supplier 104 may make the idle road roller available, via the platform 100, for use by one of the recipients 102 while the supplier 104 is concurrently using the grader and hauling machine in the initial phases of a road construction job. In the later phases of the supplier's 104 road construction job, the supplier 104 may make the hauling machine and grader available, via the platform 100, for use while the supplier 104 uses the road roller to complete the road construction job, thus recouping part of the cost of the machines while the machines would have otherwise stood idle.

One or more recipients 102 may connect to the platform 100 and make an arrangement, such as an agreement with the supplier 104, to use one or more of the assets 108 made available via the platform 100 by the suppliers 104. The use obtained via the platform 100 may include any type of use arrangement, such as borrowing, renting, bartering, and/or purchase. The recipient 102 may refer to any type entity, including an individual person or an organization, such as a company or firm. The recipient 102 may include an individual or organization involved in the construction industry or other industry involving heavy machinery, equipment, or tools. As an example, the recipient 102 may include a general contractor bidding on a job to excavate a basement area. At the time of bidding, the general contractor may not have the excavator necessary for the job. The general contractor may utilize the platform 100 to determine an appropriate type of excavator for the job, select an excavator of that type that is available for use, and make an agreement with the supplier 104 to secure usage of the excavator.

The third-party support 106 may include an entity (e.g., an individual or organization) that may provide a good or service to complement the asset 108 or use of the asset 108. As an example, the third-party support 106 may provide insurance for the asset 108, including insurance of a physical asset (e.g., casualty insurance on a borrowed hauling machine) or insurance relating to the service or personnel providing a service asset (e.g., liability insurance). The third-party support 106 may provide transportation of the asset 108 acquired via the platform 100. For instance, the third-party support 106 may be engaged to pick up a borrowed tool at the supplier's 104 site and transport the tool to the recipient's 102 site. As another example, the third-party support 106 may be engaged to service the asset 108. For instance, the third-party support 106 may be engaged to go the recipient's 102 jobsite where a borrowed excavator is located and change the oil of the excavator.

It will be appreciated that a user of the platform 100 may be defined as one of the recipients 102, one of the suppliers 104, and/or one of the third-party support 106 according to the user's role in a particular transaction. For example, a user may make available one of the user's assets 108 in one transaction (i.e., the user is the supplier 104 in that transaction) and also arrange for its own usage of another asset 108 in a second transaction (i.e., the user is the recipient 102 in the second transaction).

One or more of each of the recipients 102, the suppliers 104, and the assets 108 may be associated with (e.g., located in) a first region 120. Similarly, one or more of each of the recipients 102, the suppliers 104, and the assets 108 may be associated with (e.g., located in) a second region 122. A region may refer to a location, such as an address, or a geographical area, such as a city, county, or zip code. A region associated with one of the recipients 102 and/or suppliers 104 may be used, for example, to determine a recommended asset or third-party support 106 service for the recipient.

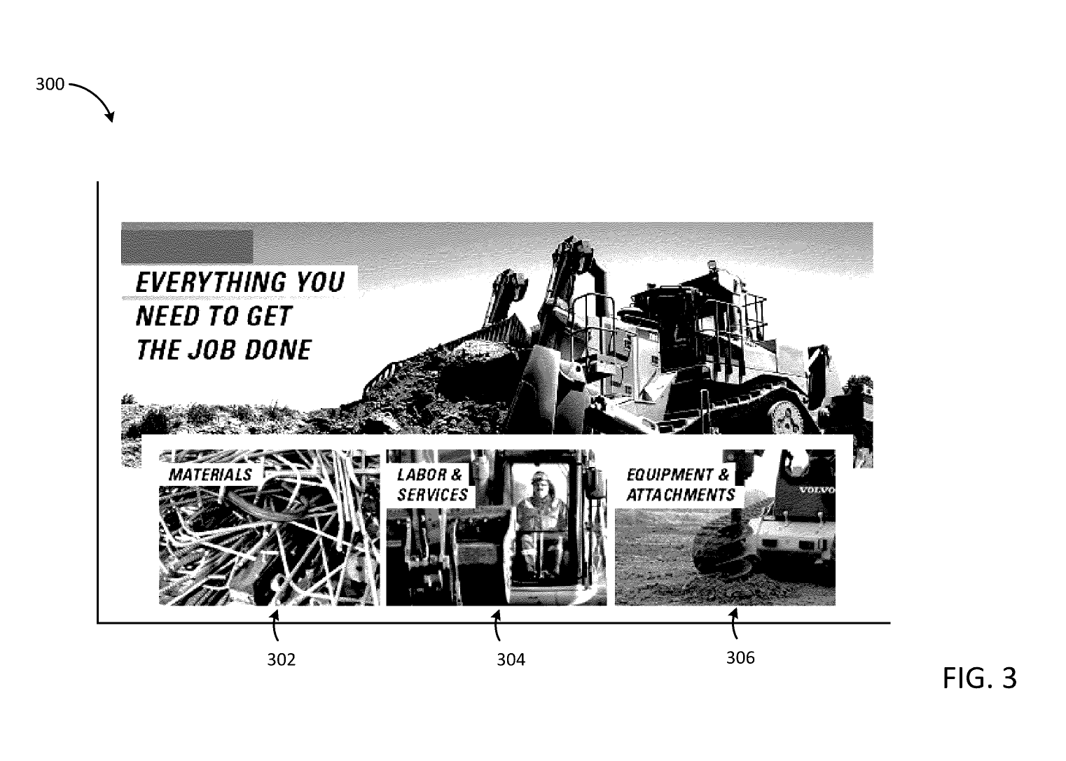

FIG. 3 depicts an example user interface 300 of the platform 100, such as may be embodied by a webpage, by which a user, such as the recipient 102, may select one of the assets 108 listed by the suppliers 104 and obtain usage of said asset 108. The user interface 300 includes a first graphical link 302 through which the recipient 102 may select a material asset, a second graphical link 304 through which the recipient 102 may select a labor or service, and a third graphical link 306 through which the recipient 102 may select a piece of equipment or attachment. The user interface 300 may include links to other assets, such as heaving machines, tooling, worksite consultation, personnel, etc.

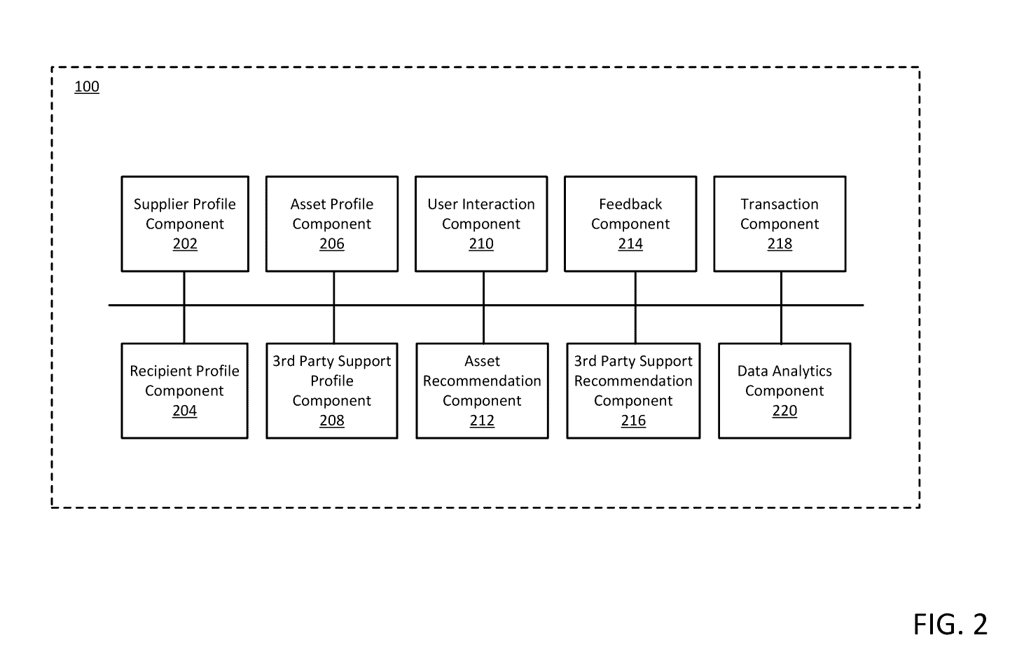

Referring to FIG. 2, the platform 100 may include a supplier profile component 202, a recipient profile component 204, an asset profile component 206, a third-party support profile component 208, a user interaction component 210, an asset recommendation component 212, a feedback component 214, a third-party support recommendation component 216, a transaction component 218, and/or a data analytics component 220. The aforementioned components may be implemented as separate or combined software components of the platform 100. Each of the components of the platform 100 may be connected to and interact with each other component of the platform 100.

The supplier profile component 202 may create one or more profiles corresponding to the respective supplier 104. The supplier profile component 202 may store, such as in local or remote storage, one or more profiles corresponding to the respective supplier. The supplier profile component 202 may further provide, such as to another component of the platform 100 or to a user interface of the platform 100, one or more profiles corresponding to the respective supplier. A supplier profile may include any information about the supplier 104. Examples of information in the supplier profile may include a name, a picture, an organization or company name, an industry, a number of years in operation, staff information, a link to a website associated with the supplier 104, a certification, such as by an equipment manufacturer or dealer network, and/or a link to a webpage on a peer review website. The supplier profile may further include a location or region, such as via a region identifier, in which the supplier 104 is located or otherwise associated.

The supplier profile component 202 may interact with the asset profile component 206 and receive a listing of the assets 108 that the supplier 104 has available in the platform 100 for use or with which the supplier 104 is otherwise associated. The listing of the assets 108 associated with the supplier 104 may, accordingly, be included in the supplier profile.

The supplier profile may include feedback associated with the supplier 104. As an example, the feedback may include a rating (e.g., a number of stars or a score) or comments, such as comments left by recipients 102 or other suppliers 104 that have transacted with the supplier 104 on the platform 100. The feedback may relate to the supplier 104 in general or may be specific to a particular transaction involving the supplier 104. The feedback in the supplier profile may be generated and received via the feedback component 214.

The supplier profile may further include a listing of past transactions in which the supplier 104 has participated. Each transaction in the listing of past transactions may include identifications of the asset 108 involved in the transaction as well as other participants in the transaction (e.g., the recipient 102, other suppliers 104, and/or third-party support 106). A link or other reference may be included in each listed transaction that points to the relevant asset profile, supplier profile, recipient profile, and/or third-party support profile.

The recipient profile component 204 may create a recipient profile for each of one or more recipients 102. The recipient profile component 204 may store, such as in local or remote storage, the recipient profiles. The recipient profile component 204 may further provide, such as to other components of the platform 100 or to a user interface of the platform 100, the recipient profiles. The recipient profile may include any information pertaining to the associated recipient 102. The recipient profile may include a name, a picture, the name of an organization, an industry, a number of years in operation, staff information, a link to a website associated with the recipient 102, and/or a link to a webpage on a peer review website. The recipient profile may additionally include an indication of a region, such as the region in which the recipient 102 or a jobsite of the recipient 102 is located.

The recipient profile may further include feedback associated with the recipient 102. The feedback may include a rating (e.g., a number of stars or a score) or comments. The feedback may be with respect to the recipient 102 in general or may be with respect to a certain transaction in which the recipient 102 has participated. The feedback may be included in the recipient profile via the feedback component 214.

The recipient profile may include a transaction history including a listing of past transactions in which the recipient 102 has participated. Each transaction in the listing of past transactions may include identifications of the asset 108 involved in the transaction as well as other participants in the transaction (e.g., the supplier 104, and/or the third-party support 106). One or more links or other references may be included in each listed transaction that points to the relevant asset profile, supplier profile, recipient profile, or third-party support profile within the platform 100.

The recipient profile may additionally include information describing the capacities of the recipient 102, such as the assets 108 of the recipient 102 (which may or may not be made available for use via the platform 100). For example, the capacities information may include information on the recipient's 102 fleet of heavy machines, including the number, year, make and model, and/or status of each of the heavy machines. To illustrate, the capacity information may indicate that the recipient 102 has two hauling machines, one excavator, and three bulldozers in the recipient's 102 fleet of heavy machines. The capacity information may further include information (e.g., number, year, make and model, status, etc.) on tools, including implements attachable to heavy machines (e.g., a bucket, shears, auger, blade, forks, and the like), available to the recipient 102. The capacity information may include compatibility information, such as with regard to the type of implements, or coupler configuration thereof, that may be attached to the one or more of the heavy machines in the recipient's 102 fleet or vice versa. The capacity information may further include information relating to personnel available to the recipient 102. For example, the available personnel information may describe the number of personnel, each of the personnel's respective capabilities or skills (e.g., crane operation capability, government bidding capability, etc.), and the availability of each personnel (e.g., the number of hours in an upcoming time period that the personnel will be available for new work). As will be discussed further herein, the capacity information may be used by the platform 100, such as the asset recommendation component 212, to determine a recommended asset for the recipient 102 to arrange usage of via the platform 100.

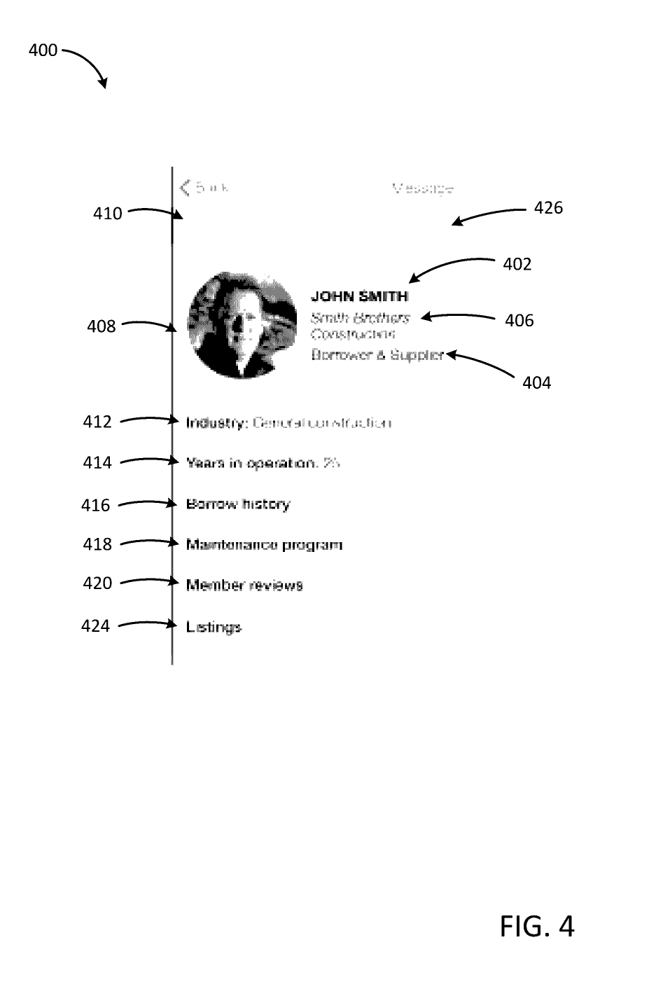

FIG. 4 shows an interface 400, such as may be embodied in a smartphone application, depicting an example profile of a platform 100 user, which in this case is both one of the suppliers 104 and one of the recipients 102. The profile shown in the interface 400 includes an indication of the user's name 402. The interface 400 includes an identification of the user's role 404. The identification of the user's role 404 may identify the user as one of the recipients 102 (referred to in the interface 400 in FIG. 4 as “borrower”), the suppliers 104, and/or the third-party support 106. The interface 400 includes an identification of an affiliated organization 406, which in this case identifies the construction entity owned by the user. The interface includes a picture 408 of the user. The interface 400 further includes an indication of the user's industry 412 and an indication of years in operation 414.

The interface 400 includes a link or action element to show a borrowing history 416. For example, upon operation of the link or action element, the interface 400 may display, such as via the transaction component 218, a listing of all transactions in which the user has arranged to use one of the assets 108 made available on the platform 100. The interface 400 further includes a link or action element to show a maintenance program 418. For example, the interface 400 may display information describing the maintenance service history of the user's assets 108. The interface 400 includes a link or action element to display reviews 420. As an example, the interface 400 may display feedback (e.g., one or more ratings or comments) pertaining to the user and submitted by other users with which the user has transacted. The interface 400 further includes a link or action element to display listings 424 of the user. For example, the interface 400 may display a list of one or more assets 108 that are made available via the platform 100 by the user.

The interface 400 includes a rating 410, such as a number of stars or numerical score. The interface 400 further includes an indication of a location 426. As an example, the indication of a location 426 may refer to a location or region and with which the user is associated, such as the region in which the user is located, has a jobsite, or operates. In addition or alternative to the elements depicted in FIG. 4, the interface 400 may include any information pertaining to the user profile, as discussed herein with respect to the recipient profile, the supplier profile, and/or the third-party support profile.

Returning to FIG. 2, the asset profile component 206 may create profiles of the assets 108, such as the assets 108 made available for use by the suppliers 104 via the platform 100. The asset profile component 206 may store, such as in local or remote storage, the asset profiles. Further, the asset profile component 206 may provide, such as to another component of the platform 100 or a user interface of the platform 100, the asset profiles. The asset profiles of the asset profile component 206 may not be strictly limited to reference to the assets 108 that are available for use, but may also include those assets 108 of the suppliers 104 which are not at a given time available but may be at a later time and/or assets 108 of the recipients 102 included in the capacity information of the recipient 102 profile, for example.

As examples, the asset profile may include an identifier of the asset 108, a picture and/or video of the asset 108, a price or price rate at which the asset 108 may be used, and/or a type identifier of the asset 108 (e.g., bucket implement, crane-operating service, hydraulic repair service, etc.).

The asset profile may include an indication of a region or location, such as the region or location at which the asset 108 is located or, in the case of a personnel asset, the region or location in which the personnel asset is capable of performing the personnel's service. For example, the asset profile for a heavy machine implement may indicate that the attachment is at a particular address. As another example, the asset profile for a crane operator asset may indicate that the crane operator is able to travel within a 50 mile radius from a particular address or is able to travel to anywhere within one or more county regions. Further, the asset profile may include information concerning delivery or transportation requirements of the asset 108. This may include whether transportation for the asset 108 must be provided by or otherwise arranged for by the recipient 102 or whether the supplier 104 will transport the asset 108 to a location requested by the recipient 102. An asset profile may include an indication of a type of transportation by which the asset 108 may be transported or other requirement(s) relating to transportation. For example, an asset profile may indicate that the asset 108 may be transported by flat-bed truck, is self-transporting (e.g., in the case of personnel), or requires a driver (e.g., in the case of a road-going heavy machine).

The asset profile may further indicate the availability of the asset 108, such as how many hours the asset 108 will be available in an upcoming time period and/or a date range during which the asset 108 is or will be available. For example, the availability indicated in the asset profile for a personnel skilled in submitting government bids may indicate that the personnel is available for the subsequent four weeks on a 40 hour per week basis.

The asset profile may include a history of the asset 108. The history of the asset 108 may include a listing of transactions, such as via the transaction component 218, in which the asset 108 was the subject. Each transaction in the listing of transactions may contain a link or other reference to the profile of the parties to the transaction (e.g., the supplier 104, the recipient 102, and/or the third-party support 106) as well as other information, such as indications of the particular service rendered, the length of time or other quantification that the asset 108, such as a service, was rendered, and/or the length of time or other quantification (e.g., number of miles, number of loads, amount of material processed) that the asset 108, such as a physical asset, was used. The history of the asset 108 may further indicate aspects of the history of the asset 108 that are without respect to a transaction in the platform 100. For example, the history of a hauling machine asset may include the total number of miles on the hauling machine.

In an aspect, the asset 108, such as a heavy machine, tool, or equipment, may include a telematics device that monitors, records, and transmits various operational metrics of the asset 108. In such a case, the telematics device and/or the asset 108 upon which the telematics device is located or otherwise associated may be in communication with the platform 100, such as via the network 110, and may provide usage data which may be incorporated into the history of the asset 108 in the asset's 108 asset profile.

The history of the asset 108 may additionally include service (e.g., maintenance) history, particularly with respect to equipment assets. For example, the history of a hauling machine asset may indicate the dates that service was performed on the hauling machine and the service tasks performed, such as changing the oil, changing the hydraulic fluid, rotating the tires, and the like. This may include not only preventive or scheduled services, but also repair services. In this manner, the recipient 102 may judge how likely the asset 108 is to perform for him or her without incident.

In an aspect, the platform 100 may be in communication, such as via the network 110, with a service organization, such as a dealer network. The service organization may track and store service information of the asset 108, such as a heavy machine, equipment, or tool. Accordingly, the platform 100 may receive service information concerning the asset 108 from the service organization, which may be incorporated into the history of the asset 108 in the asset's 108 asset profile.

The asset profile may include feedback relating to the asset 108. The feedback may include a rating, such as a star rating or a score, for the asset 108 or comments on the asset 108. The feedback may be left by one of the recipients 102 that had previously used the asset 108. As the asset 108 may be associated with one of the suppliers 104, the feedback included in the asset profile may further incorporate feedback relating to the supplier 104 associated with the asset 108. The feedback may be entered, stored, and/or provided by the feedback component 214 of the platform 100.

With particular respect to a physical asset, the asset profile may include additional technical information describing the asset 108. For example, an asset profile may include indications of the year, make, and/or model of the asset 108. The asset profile may contain technical specifications about the asset 108. For example, the asset profile for a hauling machine asset may include the weight, horsepower and/or torque, dimensions, and/or load capacity of the hauling machine. The asset profile may additionally include compatibility information, such as with regard to implements (e.g., bucket, auger, jack-hammer, shears, etc.) and heavy machines to which the implements may be coupled. The compatibility information may describe a coupling configuration of the asset 108, such as by reference to an industry standard coupling configuration. The compatibility configuration may further include a listing of compatible assets. As an example, the compatibility information in the asset profile for a bucket implement may include a listing of heavy machines, such as excavators, that are capable of accommodating the bucket implement. The listing of compatible assets may include assets 108 that are available for use, not available for use, or a combination thereof.

With particular respect to a service asset, the asset profile may include a work sample relating to the service. For example, if the asset includes a government contract bid preparation service by a certain personnel, a prior bid document prepared by the personnel may be included in the asset profile. The asset profile may additionally include a resume of a personnel whose service is made available via the platform 100.

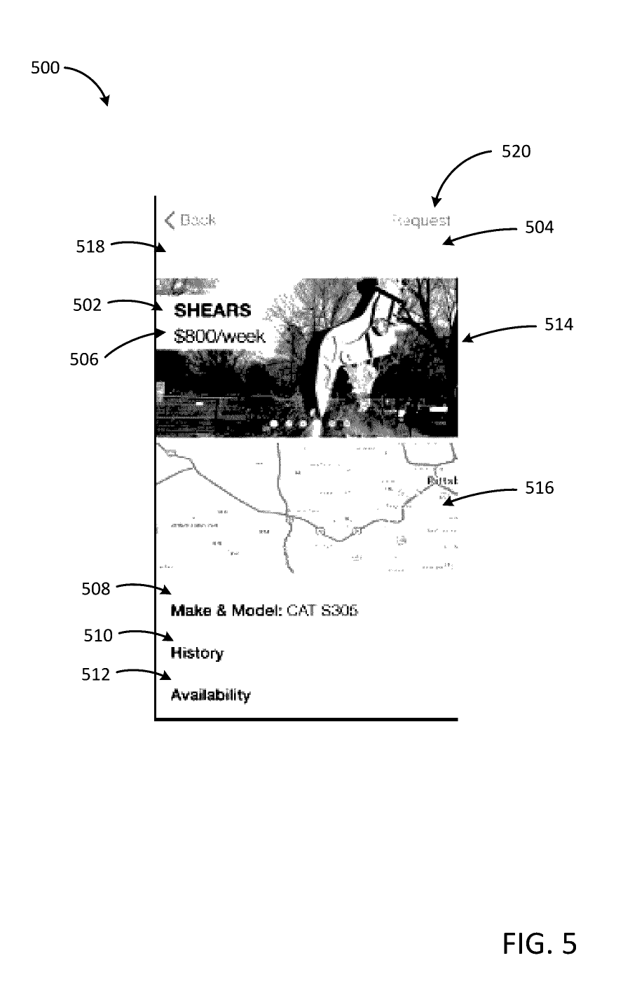

FIG. 5 shows an interface 500, such as may be embodied in a smartphone application, depicting an example asset profile of one on the assets 108. The interface 500 includes an identification of asset type 502. For example, the identification of asset type 502 may include a general category of asset (e.g., heavy machine, tool, material, personnel, or service) and/or a specific type of asset (e.g., 100-ton hauling machine, a shears attachment, etc.). The interface 500 includes an identification of a location 504. For example, the identification of the location 504 may include a location at which the asset 108 is located or a region in which the asset 108 (such as a personnel asset) may travel. The interface 500 includes an indication of a price 506. The interface 500 further includes an indication of a make and model 508 of the asset 108.

The interface 500 includes a link or action element to display a history 510 of the asset 108. For example, the interface 500 may display a usage history, service history, or maintenance history of the asset 108. The interface 500 may display a list of one or more transactions, such as via the transaction component 218, in which the asset 108 was the subject of the transaction. The interface 500 includes a link or action element to display an indication of availability 512 of the asset 108. For example, the interface 500 may display a time period in which the asset 108 is available for use and/or a number of hours for which that the asset is available. The interface 500 further includes a picture 514 and a map 516 showing the location of the asset 108. The interface 500 includes a rating 518, such as a number of stars or a numerical score.

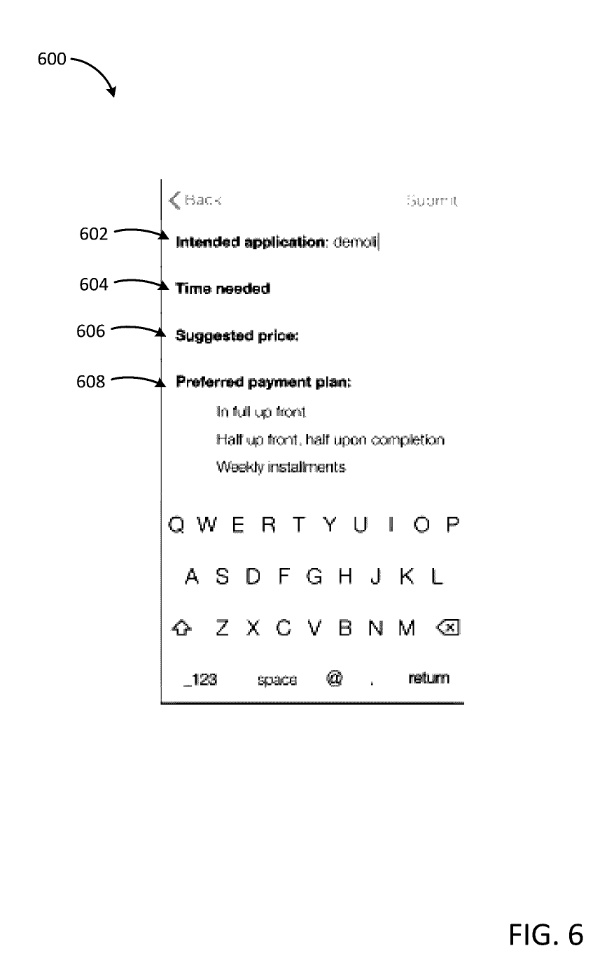

The interface 500 includes a link or action element to request 520 use of the asset 108. Upon operation of the link or action element to request 520 use of the asset 108, an interface may be displayed to submit a request to use the asset, as depicted in FIG. 6. In addition or alternative to the elements depicted in FIG. 5, the interface 500 may include any information pertaining to the asset 108, as discussed herein with respect to the asset profile.

Returning to FIG. 2, the third-party support profile component 208 may create a profile for each of one or more of the third-party support 106. The third-party support profile component 208 may store, such as in local or remote storage, the third-party support profiles. The third-party support profile component 208 may further provide, such as to another component of the platform 100 or a user interface of the platform 100, the third-party support profiles. The third-party support profile may include the name of the third-party support 106, the name of an organization which the third-party support 106 is affiliated, an identification of a service (e.g., insurance, transportation service, repair or maintenance service, etc.) offered by the third-party support 106, the number of years that the third-party support 106 has been in operation and/or provided a service, a link to the third-party support's 106 website, and/or a link to a webpage associated with the third-party support 106 on a peer review website. The third-party support may include an indication of a region, such as a region in which the third-party support 106 may offer its service.

In some aspects of the platform 100, a user of the platform 100 may embody at least two of the recipient 102, the supplier 104, and the third-party support 106. Accordingly, the supplier profile component 202, the recipient profile component 204, and/or the third-party support profile component 208 may be combined as a single component and the supplier profile, the recipient profile, and/or the third-party support profile may be embodied by a generic user profile. In such an instance, the user profile may include some or all of the aspects described herein with respect to the supplier profile, the recipient profile, and/or the third-party support profile but may have additional fields to indicate that the user may be considered one of the suppliers 104, the recipients 102, the third-party support 106, or a combination thereof.

The user interaction component 210 may facilitate interaction between users of the platform 100, such as the suppliers 104, the recipients 102, and/or the third-party support 106. As one example, the user interaction component 210 may include a forum for users to post, read, and reply to messages. The forum may be used by users, such as the recipient 102, to discuss, for example, the merits of using a particular one of the assets 108 for a particular job or task. The recipient 102 may be directed to the forum as part of the process of selecting and requesting one of the assets 108 on the platform 100. For example, such as upon being presented with a listing of assets 108, the platform 100 may prompt the recipient 102 as to whether the recipient 102 wishes to create a post in a the forum regarding an appropriate asset selection. The platform 100 may create a template of a forum post including indications of aspects of the recipient's 102 planned job and the listed assets 108. The recipient 102 may supplement the forum post template with his or her own comments before posting to the forum.

The user interaction component 210 may further include facilities for users of the platform 100 to provide feedback with respect to the suitability of one or more assets 108 for a particular job. For example, the recipient 102 may propose one or more assets 108, and other users may provide feedback on the proposed one or more assets 108, such as providing a vote or a star or score rating for each of the proposed one or more assets 108. The feedback may be used in determining a listing of recommended assets via the asset recommendation component 212, such as the assets 108 receiving the highest rating or the most votes being included in the recommended asset listing.

As another example, the user interaction component 210 may provide messaging facilities for users, such as the suppliers 104, the recipients 102, and/or the third-party support 106, to send and receive messages to one another. For instance, the supplier 104 profile may contain a link or button via which the recipient 102, or other user, may message the supplier 104, such as to ask a question regarding one of the assets 108 that the supplier 104 has made available on the platform 100. Similarly, an asset profile may include a link or action element via which the recipient 102, or other user, may message the supplier 104 associated with the asset 108.

The asset recommendation component 212 may assist the recipient 102 in selecting one of the assets 108 of which to obtain usage, such as by determining a listing of one or more recommended assets 108 based on one or more various factors relating to the recipient 102, the supplier 104, the third-party support 106, the available assets 108, and/or job data. As one example, the asset listing may be determined according to an algorithm in which one or more asset criteria (e.g., job data) supplied by the recipient 102 and/or attributes of the recipient 102 are compared or cross-referenced with one or more attributes of the suppliers 104, the assets 108, and/or the third-party support 106. In addition to the specific examples discussed below, the factors by which the determination of the asset listing may be based may generally include any aspect discussed herein in relation to the supplier profile, the recipient profile, the asset profile, and/or the third-party support profile.

The asset listing may be determined based, at least, on job data provided by the recipient 102. The term “job” is to be understood to refer generally to a prospective usage of the asset by the recipient 102 and is not limited, for example, to a single work contract. The job data may include indications of the type of the asset 108 believed to be required (e.g., the type may indicate a bucket implement, a hauling machine, or a heavy machine driver) and additional details relevant to that particular type of asset 108. For example, if a hauling machine is believed to be required, the job data may further include a make and model, a minimum load capacity, a size range, and/or a transmission type of the required hauling machine. As another example, if a heavy machine driver is believed to be required, the job data may further include a type of heavy machine that the recipient 102 plans for the driver to operate, a licensing requirement, and/or a minimum number of years of experience.

The job data may include a description, attributes, and/or parameters of the planned usage of the asset 108, such as if the recipient 102 does not know the specific type of asset 108 required or which asset 108 or type of asset 108 would be most appropriate. The attributes of the planned usage may include data pertaining to the jobsite of the planned usage, such as the size (e.g., dimensions) of the jobsite, the type(s) of ground covering (e.g., mud, dirt, paved, or a combination thereof), whether the usage is expected to be during the day or night, or whether there are noise restrictions at the jobsite. The attributes of the planned usage may include data pertaining to a material with which the job will include interaction, such as a type of material (e.g. coal, ore, dirt, gravel, concrete, etc.), an amount of material, a density of material, and/or a weight of the material. The attributes of the planned usage may further include data relating to other machines, tools, equipment, personnel, etc. that are planned to be used in conjunction with the asset 108. For example, the attributes of the planned usage may identify a type of heavy machine to which the recipient 102 plans to attach the asset 108 (e.g., a bucket implement), or vice versa. The asset recommendation component 212 may determine one or more bucket implements that are compatible with the identified type of heavy machine, or vice versa.

As an example, if the recipient 102 wishes to break up a concrete slab, the recipient 102 may indicate in the job data that the job includes breaking up concrete, the concrete slab's dimensions, the concrete slab's thickness, and the type of concrete comprising the concrete slab. The recipient 102 may be unsure whether the concrete slab may be broken up using a basic bucket implement used with the recipient's 102 machine or if a hydraulic hammer implement should instead be used. Based on the provided attributes of the concrete slab, and possibly other applicable factors as described herein, the asset recommendation component 212 may determine that a hydraulic hammer implement is the most appropriate tool for the job and determine a list of hydraulic hammer assets that are available for use.

The job data may further include an indication of desired availability, such as a date range or number of hours, a price or price range, a minimum rating of the asset 108 or supplier 104, a method or schedule of payment (e.g., full payment upfront, partial payments throughout the term of usage, etc.), and/or one or more preferred suppliers 104. The job data may additionally include an indication of region or location, such as the region or location corresponding to a jobsite at which the asset 108 is planned to be used. The indication of region or location may not necessarily be limited to the region or location in which the jobsite is located but may also include regions or locations for which the recipient 102 is able to arrange transportation, for example. The job data may include an indication of delivery or transportation requirements. For instance, the job data may indicate that the supplier 104 must provide delivery of the asset 108 to the recipient's 102 jobsite or that the personnel providing the service asset 108 must provide their own transportation to the recipient's 102 jobsite.

The asset listing may be determined based, at least, on information in the recipient's 102 recipient profile. For example, the asset listing may be based on the region or location of the recipient 102, the transaction history of the recipient 102, the capacities of the recipient 102, and/or feedback associated with the recipient 102 (e.g., feedback previously submitted by the recipient 102 with respect to the suppliers 104 or assets 108). To illustrate, if the recipient 102 wants to obtain use of a bucket implement, is located within the first region 120, and already has an excavator with a certain type of implement coupler, the asset recommendation component 212 may determine an asset listing that includes bucket implements that are located in the first region 120 and that are capable of attaching to the recipient's 102 excavator's implement coupler.

The asset listing may further be determined based, at least, on information in one or more of the suppliers' 104 supplier profiles. For example, the supplier's 104 organization or company, the supplier's 104 industry, the length of time that the supplier 104 has been in operation, a rating or other feedback relating to the supplier 104, a certification of the supplier 104, the region or location of the supplier 104, the transaction history of the supplier 104, and/or the assets 108 that the supplier 104 has made available on the platform 100. As an illustration, the recipient 102 may specify that he or she wants to obtain use of an excavator by one of the suppliers 104 that has a 4 out of 5 star rating, is located within the second region 122, the recipient 102 has borrowed or rented assets from the supplier 104 previously, and is certified by a particular excavator manufacturer. Based on these supplier 104 attributes, the asset recommendation component 212 may determine a listing of one or more excavator assets that are available for borrow or rent by one or more suppliers 104 having these attributes.

The determination of the asset listing may further be based on the assets' 108 asset profiles. For example, the type of asset 108, price of the asset 108, a region or location associated with the asset 108, a delivery or transportation requirements of the asset 108, an availability of the asset 108, a transaction, service, and/or a usage history of the asset 108, and/or a feedback relating to the asset 108 may be used in the determination of the asset listing. If the asset 108 is an equipment asset, the determination of the asset listing may be based upon the year, make, and/or model of the asset 108 and/or other technical specifications of the asset. In the case of a service asset, factors upon which the asset listing may be determined may include, for example, a length of the experience of the personnel providing the service asset 108.

Additionally, the determination of the asset listing by the asset recommendation component 212 may be based, at least, on information pertaining to the third-party support 106, such as information from the third-party support profiles. This may include an identification of one or more services offered by the third-party support 106, a region or location associated with the third-party support 106, a feedback relating to the third-party support 106, an availability of the third-party support 106, and/or an association of the third-party support 106 with one or more assets 108 and/or suppliers 104. For example, the recipient 102 may specify that he or she wishes to borrow or rent a bucket implement but will require that the bucket implement be transported from the location of the supplier 104 to the recipient's 102 jobsite by third-party support 106. The determined asset listing may include bucket implements that are eligible to be transported by third-party support 106, such as those third-party support 106 that provide tool transportation, are available in the necessary timeframe, and service the region containing the location of the supplier 104 and the recipient's 102 jobsite location.

The feedback component 214 of the platform 100 may generate, receive, store, and/or provide feedback relating to, for example, the recipients 102, the suppliers 104, the third-party support 106, and/or the assets 108. The feedback may be in various forms, such as a rating (e.g., a number of stars or a score) or comment. The feedback may be prompted for and received from a platform 100 user (e.g., the recipient 102, the supplier 104, and/or the third-party support 106) in relation to a transaction, such as after a request for borrowing or renting the asset 108, after the recipient 102 has used the asset 108 for all or a portion of the usage period, and/or after the recipient 102 has returned the asset 108 to the supplier 104. The feedback may be provided by a platform 100 user with respect to other parties to a transaction and the subject asset 108 of the transaction. For example, the recipient 102 may provide feedback for the supplier 104, the third-party support 106, and/or the asset 108. Conversely, the supplier 104 may provide feedback for the recipient 102 and/or the third-party support 106. In addition to the above, feedback may be provided in relation to a particular transaction, such as might be useful if the recipient 102 obtains usage of the same asset 108 from the same supplier 104 on separate occasions.

The third-party support recommendation component 216 may facilitate the recipient 102 selecting and/or procuring a service provided by the third-party support 106, such as a service to complement the use of the asset 108. For example, the third-party support 106 may provide transportation of the asset 108 from the supplier's 104 location to the recipient's 102 location, maintenance or repair services for the asset 108 while the asset 108 is used by the recipient 102, and/or insurance relating to the asset 108. The third-party support recommendation component 216 may determine a listing of services offered by one or more of the third-party support 106. As examples, the listing of third-party support 106 services may be provided in conjunction with the viewing of an asset profile, in conjunction with a request from the recipient 102 to the supplier 104 to obtain use of the asset 108, and/or in conjunction with a completed agreement between the supplier 104 and the recipient 102 for the recipient 102. The determination of the listing of third-party support 106 services may be based, for example, on the various characteristics or aspects of the asset 108 included in the asset's 108 asset profile, the supplier 104 included in the supplier's 104 supplier profile, the recipient 102 included in the recipient's 102 recipient profile, and/or the terms of the usage. For example, if the recipient 102 has completed an agreement to obtain use of a bucket implement from the supplier 104, the listing of third-party support 106 services may include transportation services offered by one or more third-party support 106 based on the third-party support's 106 ability to transport a bucket implement, the availability of the third-party support 106 with respect to the start and/or end date of the asset 108 usage term, and a region that the third-party support 106 is able to serve.

The transaction component 218 may receive, store, and/or provide the transactions performed on the platform 100. A transaction may represent an agreement for the supplier 104 to allow the recipient 102 to use the asset 108 in return for consideration provided by the recipient 102. A transaction may include identifications of the supplier 104, the recipient 102, the third-party support 106, the asset 108, the price, and/or the term of the asset 108 usage (e.g., length of time, man-hours, operation-hours, or other metric of usage). The transaction component 218 may provide a transaction listing according to various criteria, such as those transactions involving the supplier 104, the recipient 102, the third-party support 106, or one of the assets 108. The transaction listing may be used to provide a transaction history which, in turn, may be used in the supplier profile, the recipient profile, the third-party support profile, and/or the asset profile. The transaction history may further be used in the asset recommendation component 212 to determine a listing of recommended assets 108.

The platform 100 may further include the data analytics component 220. The data analytics component 220 may aggregate and analyze the various data received, stored, and/or provided by the platform 100, such as information received, stored, and/or provided in the supplier profiles of the supplier profile component 202, the recipient profiles of the recipient profile component 204, the asset profiles of the asset profile component 206, the third-party support profiles of the third-party support profile component 208, listings of recommended assets 108 of the asset recommendation component 212, the feedback data of the feedback component 214, the listings of recommended third-party support 106 of the third-party support recommendation component 216, and/or the transactions of the transaction component 218. Based on the aggregated data, the data analytics component 220 may provide a resultant data, such as data that may be useful in making business decisions relating to the manufacture, sales, and/or marketing of equipment or services. The resultant data may include data reflecting a trend with respect to the assets 108, the suppliers 104, the recipients 102, and/or the third-party support 106.

As an example, the data analytics component 220 may aggregate and analyze the transactions that have involved a particular model of bucket implement, along with data from associated asset and recipient profiles, such as region data from the recipient profiles, and determine a resultant data. The resultant data may indicate that a high number of recipients 102 in the first region 120 borrowed or rented a bucket implement of that particular model while a much lower number of recipients 102 in the second region 122 borrowed or rented a bucket implement of that particular model. The resultant data in this case may reflect a higher demand for the particular model of bucket implement in the first region 120 and a bucket implement manufacturer or dealer may adjust their sales and marketing efforts accordingly.

As another example, the data analytics component 220 may aggregate and analyze transactions, including price data, involving a particular model of excavator, along with data from associated asset profiles. The data analytics component 220 may determine the resultant data based on the prices at which the particular model of excavator was rented out and the instances of feedback (e.g., feedback scores) left by the recipients 102 with respect to the assets 108 corresponding to the particular model of excavator. The resultant data for this example may indicate an average price at which the particular type of excavator is rented out and an average feedback score left by the recipients 102 that used the particular type of excavator. If the average price and the average feedback are both lower than expected, such as by the manufacturer of the excavator, the resultant data may indicate that there is a quality problem with the excavator, such as a manufacturing or design defect. On the other hand, if the average price is lower than expected but the average feedback score is high, the resultant data may indicate that the market has a poor perception of the excavator but the excavator performs well when used. In this case, a manufacturer or dealer of the excavator may use the resultant data to adjust its marketing and promotional strategy.

### INDUSTRIAL APPLICABILITY

The industrial applicability of the system for sharing equipment and personnel described herein will be readily appreciated from the foregoing discussion.

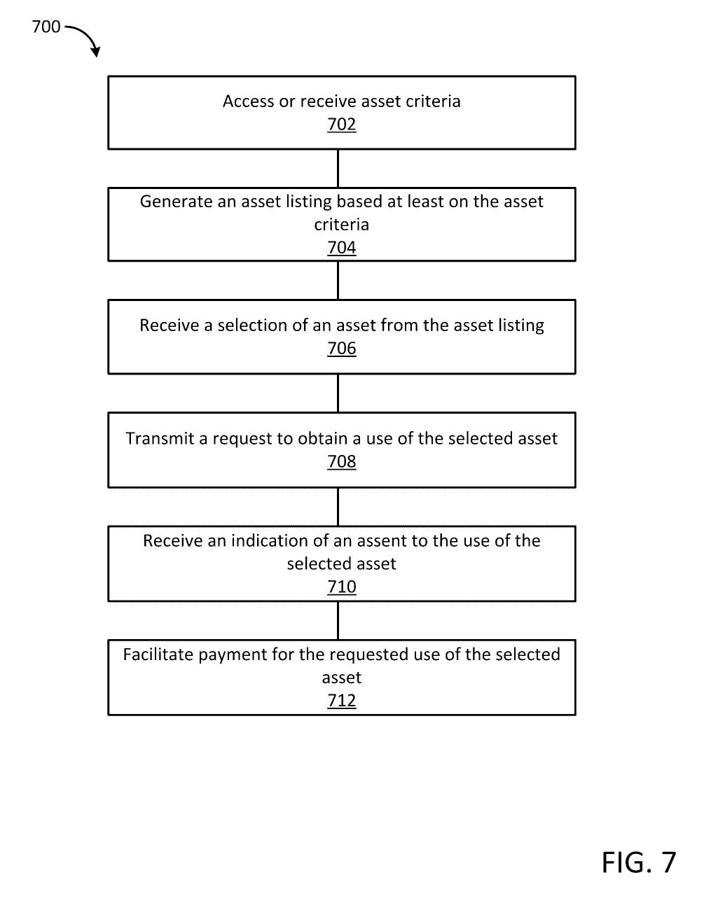

FIG. 7 illustrates a process flow chart for a method 700 in which a user, such as the recipient 102, of the platform 100 may obtain usage of one of the assets 108. For illustration, the operations of the method 700 will be discussed in reference to FIGS. 1 and 2. At step 702, asset criteria may be access or received by, for example, the platform 100. The asset criteria may be contemporaneously provided, such as via input on an interface of the platform 100, by the recipient 102 and/or may include criteria previously stored, accessed, and/or received. The asset criteria may include job data, data from the recipient's 102 recipient profile, data from the suppliers' 104 supplier profiles, data from the assets' 108 asset profiles, and/or data from the third-party support's 106 third-party support profiles.

Job data may be generally understood to include any criteria provided by a platform 100 user, such as the recipient 102, with respect to a desired attribute, or lack thereof, of the desired asset 108 and/or the recipient's 102 planned usage of the asset 108. The job data may include an indication of the type of asset 108 desired and various attributes pertaining to the indicated type of asset 108. For example, the job data may indicate that a shear implement is desired, the shear implement should be configured with a particular type of coupler, the shear implement should have a specified minimum cutting-capacity rating. Further, the job data may include one or more parameters relating to a planned usage, such as an amount and type of material to be moved at the recipient's 102 jobsite, as an example.

The job data may further include an indication of a period of time, a price or price range, a rating of the asset 108 or supplier 104, a method or schedule of payment, a quantification of usage of the asset 108, a preferred supplier 104, and/or a delivery or transportation requirement of the asset 108. In addition, the job data may include an indication of a region or location. For example, the job data may include an indication that the asset 108 must be located in the first region 120.

The data from the recipient's 102 recipient profile may include, as examples, an indication of the recipient's 102 location or region (e.g., the first region 120 or the second region 122), the transaction history of the recipient 102, the current capabilities of the recipient 102 (e.g., information on the recipient's 102 fleet of heavy machines or the recipient's 102 current personnel capabilities), and/or feedback associated with the recipient 102.

The data from the suppliers' 104 supplier profiles may include, for example, an indication of an organization with which the supplier 104 is affiliated, the supplier's 104 industry, the length of time that the supplier 104 has been in operation, a feedback associated with the supplier 104, a region or location of the supplier 104, the transaction history of the supplier 104, and/or the assets 108 associated with the supplier 104 (e.g., the assets 108 that the supplier 104 has made available on the platform 100 for usage).

The data from the assets' 108 asset profiles may include, for example, an indication of the type of the asset 108, a price (e.g., the price to obtain usage of the asset 108), a region or location associated with the asset 108, an availability of the asset 108, a history (e.g., a transaction history, a service history, and/or a usage history) of the asset 108, and/or a feedback associated with the asset 108. In the case that the asset 108 is a physical asset, such as a heavy machine, tool, or equipment, the data from the asset's 108 asset profile may include a year, make, and model of the asset 108 and/or other technical specifications. Technical specifications may include, as examples, a load capacity for a hauling machine, a coupler configuration for a bucket implement, or the lifting capacity of a crane. In the case that the asset 108 is a service asset, such as may be provided by a heavy machine operator or a job bid preparation specialist, the data from the asset's 108 profile may include, as examples, the number of years of experience of the personnel providing the service or a certification (such as a certification provided by a heavy machine manufacturer) of the personnel providing the service.

The data from the third-party support's 106 third-party support profile may include, as examples, an indication of a service offered by the third-party support 106, a region or location associated with the third-party support 106, a feedback associated with the third-party support 106, an availability of the third-party support 106, and/or an association with one or more assets 108 or suppliers 104 and the third-party support 106.

The asset criteria may additionally include user interaction data, such as data generated, stored, and/or provided by the user interaction component 210. For example, the user interaction component 210 may allow users (e.g., recipients 102, suppliers 104, and/or third-party support 106) to provide a rating or a vote for one or more assets 108 that the user believes would be the best choice for the recipient 102 to obtain usage of. The rating or voting data, such as that reflecting that a particular asset 108 is regarded by the users as the most suitable, may accordingly be included in the user interaction data.

At step 704, an asset listing may be generated or determined based at least on the asset criteria. The asset listing may be generated or determined by the asset recommendation component 212. The asset listing may comprise one or more identifications of assets 108 and may be displayed to a user, such as the recipient 102, via a user interface. In general, the asset listing may be determined by cross-referencing or comparing one or more aspects of the asset criteria supplied by the recipient 102 (e.g., the job data) and/or attributes of the recipient 102 (e.g. the data included in the recipient's 102 recipient profile) with the one or more attributes of the suppliers 104 (e.g., the data included in the suppliers' 104 supplier profile), the assets 108 (e.g., the data included in the assets' 108 asset profiles), and/or the third-party support 106 (e.g., the data included in the third-party support's 106 third-party support profile) to arrive at a determination of one or more matching assets 108.

As one detailed example of determining the asset listing, the asset criteria may include an indication by the recipient 102 that the recipient 102 wishes to obtain usage of a jackhammer. The asset criteria may further include job data provided by the recipient 102 indicating that the recipient 102 requires that the jackhammer be obtained from one of the suppliers 104 with which the recipient 102 has transacted previously and rated at least 4 out of 5 stars, that the jackhammer be located within the first region 120, that the jackhammer be available from August 1 through August 10, and that the price for usage of the jackhammer is less than $50 per day. The platform 100, such as via the asset recommendation component 212, may determine the asset listing of recommended jackhammers by cross-referencing and/or comparing each aspect of the job data provided by the recipient 102 with data from the respective profile of the recipient 102, the suppliers 104, the assets 108, and the third-party support 106. For instance, the asset listing based on the aforementioned asset criteria may include an identification of a first jackhammer that is offered by one of the suppliers 104 from which the recipient 102 had rented via the platform 100 a hauling machine in the previous month and had given the supplier 104 a 5 star rating, is located within the first region 120, is available for the whole of August, and is priced at $40 a day.

As another detailed example of determining the asset listing, the asset criteria may include job data provided by the recipient 102 that the recipient 102 wishes to dig a trench and that the planned trench will have a certain length, width, and depth. The job data may further indicate that the trench will be dug in soil having particular attributes, such as a large proportion of clay and numerous rocks. The recipient 102 in this case does not know what type of machine or tool would be best suited to dig the trench, such as whether the recipient 102 should use a bucket-equipped excavator, a heavy tracked trenching machine, a portable trenching machine, or a trenching implement. The asset criteria may further include data from the recipient's 102 recipient profile that indicates that the recipient 102 already owns an excavator-type machine equipped with an auger implement, but not a bucket implement, and that the recipient's 102 machine is configured to accommodate certain types of implement couplers. Based on the indicated job (i.e., to dig a trench), the length, width, and depth of the trench, the indications of a large proportion of clay and numerous rocks in the soil, it may be determined that either a heavy tracked trencher machine or a bucket-equipped excavator would be the most suitable type of asset for the job. However, since the asset criteria indicates that the recipient 102 already owns an excavator-type machine capable of accommodating a bucket implement, and in conjunction with the greater price of the heavy tracked trencher machine compared to the bucket implement, the determined asset listing may include identifications of one or more bucket implements that are compatible with the particular type of coupler of the recipient's 102 excavator-type machine. Further, the asset listing may include identifications of only those bucket implements that are located within a region identified as associated with the recipient 102 in the recipient's 102 recipient profile.

At step 706, a selection of one of the assets 108 from the asset listing may be received. The selection of one of the assets 108 may be provided, for example, by the recipient 102 via a user interface of the platform 100.

At step 708, a request may be transmitted, or caused to be transmitted, to obtain a use of the selected asset 108. The request may be transmitted by the platform 100 and may be transmitted on behalf of the recipient 102. The request may be transmitted to the supplier 104 associated with the selected asset 108. The request may be in the form of a message received within platform 100 and/or an email sent to the email address of the supplier 104. An email to the supplier 104 may include a link or other reference to view the request on the platform 100. The request may include an identification of the asset 108 selected by the recipient 102, an identification of the recipient 102, and/or other details of the requested usage, such as the requested start time of the usage, a length or other quantification of the usage, and/or the region or location of the usage. The request may further include any data from the recipient's 102 recipient profile, such a rating or other feedback associated with the recipient 102 and/or a pertinent transaction history of the recipient 102 (e.g., a listing of past transactions between the recipient 102 and the supplier 104). In an aspect, various modifications to the terms of the usage may be proposed, such as a proposed price that may be lower than the price from the asset's asset profile.

FIG. 6 depicts an example user interface 600, such as may be embodied in a smartphone application, that may be used to submit a request. The user interface 600 includes identifications of an intended usage 602 of the asset 108, a time needed 604 for the usage, a suggest price 606, and a preferred payment method 608.

Returning to FIG. 7, at step 710, an indication of an assent to the use of the selected asset may be received, such as by the platform 100. The indication of assent may be received in response to the request to obtain usage of the asset 108 and may be provided, transmitted, or otherwise caused to be received by the supplier 104. To illustrate, the supplier 104 may have received the request from the recipient 102 for the recipient 102 to obtain usage of one of the supplier's 104 assets 108 made available on the platform 100. The supplier 104 may have reviewed the terms of the usage, such as the price and the planned usage period, as well as the rating of the recipient left by other suppliers 104, and decided to permit the recipient 102 to use the asset 108. Accordingly, the supplier 104 may transmit his assent to the requested usage. As some examples, the indication of the assent may include a selection of a link or button on a user interface of the platform 100 or may include a reply email to the email containing the request.

At step 712, payment for the requested use of the selected asset 108 may be facilitated, such as by the platform 100. Payment may include a transfer of monetary units or other forms of consideration, such as a reciprocal use of one of the recipient's 102 assets 108. Facilitating payment may include receiving payment from the recipient 102 and providing the payment to the supplier 104. Facilitating payment may further include receiving payment information from the recipient 102, without transfer of payment, and providing the supplier 104 with the recipient's 102 payment information, wherein the supplier 104 may then use the recipient's 102 payment information to obtain the payment. For example, the recipient's 102 payment information may include a credit card number or a bank routing and account number. In other instances, facilitating payment may include receiving from the supplier 104 an account identifier, such as an account identifier to an online payment system, which may then be provided to the recipient 102 for the recipient 102 to effectuate payment to the supplier's 104 account.

It will be appreciated that facilitating payment may occur before, during, or subsequent to the recipient's 102 usage of the asset 108. Facilitating payment may further include a partial payment or multiple payments, such as if the terms of the usage call for an initial 50% payment with the final 50% payment not due until after the usage is complete and the recipient 102 has returned the asset 108 to the supplier 104.

In an aspect, an operator of the platform 100 may deduct a portion of the payment, such as on a percentage or per-transaction basis, before providing the remaining portion of the payment to the supplier 104. For purposes of this disclosure, the remaining portion of the payment provided to the supplier 104 will still be considered to be encompassed by the term “the payment.”

In an aspect, a listing of one or more services provided by the third-party support 106 may be determined and provided, such as via the third-party support recommendation component 216, to the recipient 102 and/or the supplier 104. As discussed further herein, third-party support 106 services may include any service that may complement the usage of the asset 108, such as transportation, insurance, or maintenance service. The third-party support 106 service listing may be determined and/or provided in conjunction with any of the steps 702-712 of the method 700. For example, the third-party support 106 service listing may be determined and/or provided in conjunction with the display of the asset listing of step 704, such as providing an identification of one or more third-party support 106 services that may be provided with respect to each asset 108 in the asset listing so that the recipient 102 may be informed of what third-party support 106 services may be available if the recipient 102 selects that asset 108. As other examples, the third-party support 106 service listing may be determined and/or provided in conjunction with the selection of the asset 108 of step 706 or in conjunction with facilitation of the payment of step 712.

In a similar manner to the determination of the asset listing, the determination of the third-party support 106 service listing may be based on the asset criteria, including the job data, data from the asset's 108 asset profile, data from the recipient's 102 recipient profile, data from the supplier's 104 recipient profile, and data from the third-party support's 106 third-party support profile. For example, if the recipient 102 selected a tracked excavator (which is typically not permitted to be driven on paved roads) from the asset listing of step 704 and specified in the job data of the asset criteria that the tracked excavator is to be used at a jobsite located 100 miles from the location at which the supplier 104 stores the tracked excavator, the third-party support 106 service listing may include identifications of flat-bed transportation services offered by one or more third-party support 106 that are capable of transporting the tracked excavator and service the region encompassing the storage location of the tracked excavator and the recipient's 102 jobsite.

A selection of a third-party support 106 service from the third-party support 106 service listing may be received, such by the platform 100. The selection of the third-party support 106 service may be provided by the recipient 102 or, in some instances, the supplier 104 since the supplier 104 may be required to arrange transportation for the asset 108 or may wish to insure the asset 108.

Similar to steps 708 and steps 710 but with regard to the selected third-party support 106 service instead of the selected asset, a request to obtain the selected third-party support 106 service may be transmitted or caused to be transmitted and an indication of an assent to the third-party support 106 providing the service may be received. The request may be transmitted by the platform 100 on behalf of the requesting entity, such as the recipient 102 or the supplier 104, and to the third-party support 106. The indication of assent may be received by the platform 100 from the third-party support 106.

Again similar to step 712, the platform 100 may facilitate payment for the third-party support 106 service. For example, the platform 100 may receive payment from the recipient 102 or supplier 104 that requested the third-party support 106 service and transfer the payment to the third-party support 106.

Whether such functionality is implemented as hardware or software depends upon the design constraints imposed on the overall system. Skilled persons may implement the described functionality in varying ways for each particular application, but such implementation decisions should not be interpreted as causing a departure from the scope of the disclosure. In addition, the grouping of functions within a module, block, or step is for ease of description. Specific functions or steps may be moved from one module or block without departing from the disclosure.

The various illustrative logical blocks and modules described in connection with the aspects disclosed herein may be implemented or performed with a general purpose processor, a digital signal processor (DSP), application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the aspects disclosed herein may be embodied directly in hardware, in a software module executed by a processor (e.g., of a computer), or in a combination of the two. A software module may reside, for example, in RAM memory, flash memory, ROM memory, EPROM memory, EEPROM memory, registers, hard disk, a removable disk, a CD-ROM, or any other form of storage medium. An exemplary storage medium may be coupled to the processor such that the processor may read information from, and write information to, the storage medium. In the alternative, the storage medium may be integral to the processor. The processor and the storage medium may reside in an ASIC.

In at least some aspects, a processing system (e.g., the platform 100 or one or more computing devices executing software embodying the platform 100) that implements a portion or all of one or more of the technologies described herein may include a general-purpose computer system that includes or is configured to access one or more computer-accessible media.

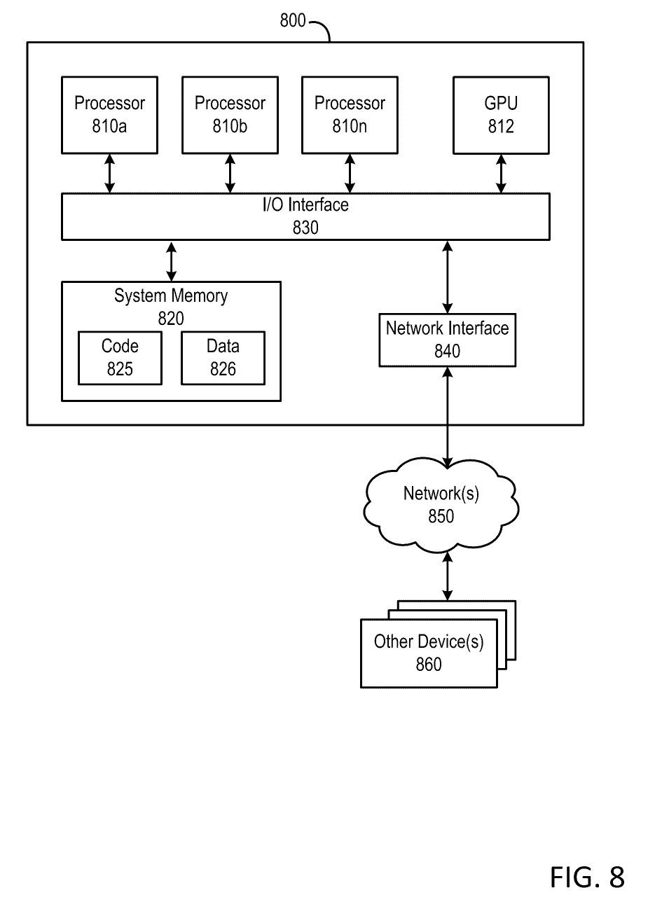

FIG. 8 depicts a general-purpose computer system that includes or is configured to access one or more computer-accessible media. In the illustrated aspect, a computing device 800 may include one or more processors 810a, 810b, and/or 810n (which may be referred herein singularly as the processor 810 or in the plural as the processors 810) coupled to a system memory 820 via an input/output (I/O) interface 830. The computing device 800 may further include a network interface 840 coupled to an I/O interface 830.

In various aspects, the computing device 800 may be a uniprocessor system including one processor 810 or a multiprocessor system including several processors 810 (e.g., two, four, eight, or another suitable number). The processors 810 may be any suitable processors capable of executing instructions. For example, in various aspects, the processor(s) 810 may be general-purpose or embedded processors implementing any of a variety of instruction set architectures (ISAs), such as the x86, PowerPC, SPARC, or MIPS ISAs, or any other suitable ISA. In multiprocessor systems, each of the processors 810 may commonly, but not necessarily, implement the same ISA.

In some aspects, a graphics processing unit (“GPU”) 812 may participate in providing graphics rendering and/or physics processing capabilities. A GPU may, for example, include a highly parallelized processor architecture specialized for graphical computations. In some aspects, the processors 810 and the GPU 812 may be implemented as one or more of the same type of device.

The system memory 820 may be configured to store instructions and data accessible by the processor(s) 810. In various aspects, the system memory 820 may be implemented using any suitable memory technology, such as static random access memory (“SRAM”), synchronous dynamic RAM (“SDRAM”), nonvolatile/Flash®-type memory, or any other type of memory. In the illustrated aspect, program instructions and data implementing one or more desired functions, such as those methods, techniques and data described above, are shown stored within the system memory 820 as code 825 and data 826.

In one aspect, the I/O interface 830 may be configured to coordinate I/O traffic between the processor(s) 810, the system memory 820 and any peripherals in the device, including a network interface 840 or other peripheral interfaces. In some aspects, the I/O interface 830 may perform any necessary protocol, timing or other data transformations to convert data signals from one component (e.g., the system memory 820) into a format suitable for use by another component (e.g., the processor 810). In some aspects, the I/O interface 830 may include support for devices attached through various types of peripheral buses, such as a variant of the Peripheral Component Interconnect (PCI) bus standard or the Universal Serial Bus (USB) standard, for example. In some aspects, the function of the I/O interface 830 may be split into two or more separate components, such as a north bridge and a south bridge, for example. Also, in some aspects some or all of the functionality of the I/O interface 830, such as an interface to the system memory 820, may be incorporated directly into the processor 810.

The network interface 840 may be configured to allow data to be exchanged between the computing device 800 and other device or devices 860 attached to a network or networks 850, such as other computer systems or devices, for example. In various aspects, the network interface 840 may support communication via any suitable wired or wireless general data networks, such as types of Ethernet networks, for example. Additionally, the network interface 840 may support communication via telecommunications/telephony networks, such as analog voice networks or digital fiber communications networks, via storage area networks, such as Fibre Channel SANs (storage area networks), or via any other suitable type of network and/or protocol.

In some aspects, the system memory 820 may be one aspect of a computer-accessible medium configured to store program instructions and data as described above for implementing aspects of the corresponding methods and apparatus. However, in other aspects, program instructions and/or data may be received, sent, or stored upon different types of computer-accessible media. Generally speaking, a computer-accessible medium may include non-transitory storage media or memory media, such as magnetic or optical media, e.g., disk or DVD/CD coupled to computing device the 800 via the I/O interface 630. A non-transitory computer-accessible storage medium may also include any volatile or non-volatile media, such as RAM (e.g., SDRAM, DDR SDRAM, RDRAM, SRAM, etc.), ROM, etc., that may be included in some aspects of the computing device 800 as the system memory 820 or another type of memory. Further, a computer-accessible medium may include transmission media or signals, such as electrical, electromagnetic or digital signals, conveyed via a communication medium, such as a network and/or a wireless link, such as those that may be implemented via the network interface 840. Portions or all of multiple computing devices, such as those illustrated in FIG. 8, may be used to implement the described functionality in various aspects; for example, software components running on a variety of different devices and servers may collaborate to provide the functionality. In some aspects, portions of the described functionality may be implemented using storage devices, network devices or special-purpose computer systems, in addition to or instead of being implemented using general-purpose computer systems. The term “computing device,” as used herein, refers to at least all these types of devices and is not limited to these types of devices.

It should also be appreciated that the systems in the figures are merely illustrative and that other implementations might be used. Additionally, it should be appreciated that the functionality disclosed herein might be implemented in software, hardware, or a combination of software and hardware. Other implementations should be apparent to those skilled in the art. It should also be appreciated that a server, gateway, or other computing node may include any combination of hardware or software that may interact and perform the described types of functionality, including without limitation desktop or other computers, database servers, network storage devices and other network devices, PDAs, tablets, cellphones, wireless phones, pagers, electronic organizers, Internet appliances, and various other consumer products that include appropriate communication capabilities. In addition, the functionality provided by the illustrated modules may in some aspects be combined in fewer modules or distributed in additional modules. Similarly, in some aspects the functionality of some of the illustrated modules may not be provided and/or other additional functionality may be available.

Each of the operations, processes, methods, and algorithms described in the preceding sections may be embodied in, and fully or partially automated by, code modules executed by at least one computer or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto may be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example aspects. The example systems and components described herein may be configured differently than described. For example, elements may be added to, removed from, or rearranged compared to the disclosed example aspects.

It will also be appreciated that various items are illustrated as being stored in memory or on storage while being used, and that these items or portions of thereof may be transferred between memory and other storage devices for purposes of memory management and data integrity. Alternatively, in other aspects some or all of the software modules and/or systems may execute in memory on another device and communicate with the illustrated computing systems via inter-computer communication. Furthermore, in some aspects, some or all of the systems and/or modules may be implemented or provided in other ways, such as at least partially in firmware and/or hardware, including, but not limited to, at least one application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the modules, systems and data structures may also be stored (e.g., as software instructions or structured data) on a computer-readable medium, such as a hard disk, a memory, a network, or a portable media article to be read by an appropriate drive or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other aspects. Accordingly, the disclosure may be practiced with other computer system configurations.

Conditional language used herein, such as, among others, “may,” “could,” “might,” “may,” “e.g.,” and the like, unless specifically stated otherwise, or otherwise understood within the context as used, is generally intended to convey that certain aspects include, while other aspects do not include, certain features, elements, and/or steps. Thus, such conditional language is not generally intended to imply that features, elements, and/or steps are in any way required for at least one aspects or that at least one aspects necessarily include logic for deciding, with or without author input or prompting, whether these features, elements, and/or steps are included or are to be performed in any particular aspect. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example aspects have been described, these aspects have been presented by way of example only, and are not intended to limit the scope of aspects disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of aspects disclosed herein. The accompanying claims and their equivalents are intended to cover such forms or modifications as would fall within the scope and spirit of certain aspects disclosed herein.

The preceding detailed description is merely exemplary in nature and is not intended to limit the disclosure or the application and uses of the disclosure. The described aspects are not limited to use in conjunction with a particular type of machine. Hence, although the present disclosure, for convenience of explanation, depicts and describes particular machine, it will be appreciated that the assembly and electronic system in accordance with this disclosure may be implemented in various other configurations and may be used in other types of machines. Furthermore, there is no intention to be bound by any theory presented in the preceding background or detailed description. It is also understood that the illustrations may include exaggerated dimensions to better illustrate the referenced items shown, and are not consider limiting unless expressly stated as such.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

The disclosure may include communication channels that may be any type of wired or wireless electronic communications network, such as, e.g., a wired/wireless local area network (LAN), a wired/wireless personal area network (PAN), a wired/wireless home area network (HAN), a wired/wireless wide area network (WAN), a campus network, a metropolitan network, an enterprise private network, a virtual private network (VPN), an internetwork, a backbone network (BBN), a global area network (GAN), the Internet, an intranet, an extranet, an overlay network, a cellular telephone network, a Personal Communications Service (PCS), using known protocols such as the Global System for Mobile Communications (GSM), CDMA (Code-Division Multiple Access), Long Term Evolution (LTE), W-CDMA (Wideband Code-Division Multiple Access), Wireless Fidelity (Wi-Fi), Bluetooth, and/or the like, and/or a combination of two or more thereof.

Additionally, the various aspects of the disclosure may be implemented in a non-generic computer implementation. Moreover, the various aspects of the disclosure set forth herein improve the functioning of the system as is apparent from the disclosure hereof. Furthermore, the various aspects of the disclosure involve computer hardware that it specifically programmed to solve the complex problem addressed by the disclosure. Accordingly, the various aspects of the disclosure improve the functioning of the system overall in its specific implementation to perform the process set forth by the disclosure and as defined by the claims.

Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context.

We claim:

1. A method for obtaining use, by a recipient, of an asset made available by a supplier via an asset sharing platform, the method comprising:
receiving, by one or more processors, first data comprising one or more criteria associated with a desired asset and an indication of a planned usage of the desired asset, wherein the desired asset comprises one or more of a heavy machine, a heavy machine implement, and a service relating to heavy machines;
receiving, by the one or more processors, second data comprising at least one of data associated with the recipient, data associated with a plurality of suppliers, and data associated with a plurality of available assets;
causing, by the one or more processors, display of an asset listing comprising identifications of one or more assets of the plurality of available assets, the displayed asset listing determined based, at least, on the first data and the second data; and
receiving, by the one or more processors, an indication of a selected asset from the one or more assets of the displayed asset listing.

2. The method of claim 1, further comprising:
causing to transmit, to a supplier associated with the selected asset, a request to obtain use of the selected asset by the recipient; and
receiving an indication of an assent by the supplier associated with the selected asset to the use of the selected asset by the recipient.

3. The method of claim 1, wherein the indication of the planned usage comprises data pertaining to a jobsite.

4. The method of claim 3, wherein the data pertaining to the jobsite comprises at least one of an indication of a size of the jobsite, an indication of a type of ground covering of the jobsite, an indication of an amount of daylight at the jobsite, and an indication of a noise restriction at the jobsite.

5. The method of claim 1, wherein the indication of the planned usage comprises data pertaining to a material.

6. The method of claim 5, wherein the data pertaining to the material comprises at least one of an indication of a type of the material, an indication of an amount of the material, an indication of a density of the material, and an indication of a weight of the material.

7. The method of claim 1, wherein the indication of the planned usage comprises data pertaining to at least one of a heavy machine planned to be used with the desired asset, a heavy machine implement planned to be used with the desired asset, or a heavy machine operator planned to be used with the desired asset.

8. A method for obtaining use, by a recipient, of an asset made available by a supplier via an asset sharing platform, the method comprising:
receiving, by one or more processors, first data comprising one or more criteria associated with a desired asset, wherein the desired asset comprises one or more of a heavy machine, a heavy machine implement, and a service relating to heavy machines;
receiving, by the one or more processors, second data comprising at least one of data associated with the recipient, data associated with a plurality of suppliers, and data associated with a plurality of available assets;
receiving, by the one or more processor, third data comprising data associated with a plurality of third-party support services;
causing, by the one or more processors, display of an asset listing comprising identifications of one or more assets of the plurality of available assets, the displayed asset listing determined based, at least, on the first data and the second data;
causing, by the one or more processors, display of a third-party support service listing comprising identifications of one or more third-party support services, the displayed third-party support service listing determined based, at least, on the third data and at least one of the first data and the second data;
receiving, by the one or more processors, an indication of a selected asset from the one or more assets of the displayed asset listing; and
receiving, by the one or more processors, an indication of a selected third-party support service from the one or more third-party support services of the displayed third-party support service listing.

9. The method of claim 8, further comprising:
causing to transmit, to a supplier associated with the selected asset, a request to obtain use of the selected asset by the recipient;
receiving an indication of an assent by the supplier associated with the selected asset to the use of the selected asset by the recipient;
causing to transmit, to a third-party support associated with the selected third-party support service, a request to obtain use of the selected third-party support service; and
receiving an indication of an assent by the third-party support associated with the selected third-party support service to the use of the selected third-party support service.

10. The method of claim 8, wherein the selected third-party support service comprises at least one of transportation service, repair service, maintenance service, or insurance service.

11. The method of claim 8, wherein the displayed third-party support service listing is further based on the displayed asset listing.

12. The method of claim 8, wherein the displayed third-party support service listing is further based on the selected asset.

13. The method of claim 12, wherein the displayed third-party support service listing is further based on a transportation requirement of the selected asset.

14. The method of claim 8, wherein the displayed third-party support service listing is further based on an indication of a region associated with at least one of the selected asset, a supplier associated with the selected asset, and the recipient.

15. A method for obtaining use, by a recipient, of an asset made available by a supplier via an asset sharing platform, the method comprising:
receiving, by one or more processors, first data comprising one or more criteria associated with a desired asset, wherein the desired asset comprises one or more of a heavy machine, a heavy machine implement, and a service relating to heavy machines;
receiving, by the one or more processors, second data comprising an indication of a first region associated with the recipient, an indication of a second region associated with at least one supplier of a plurality of suppliers, and data associated with a plurality of available assets;
causing, by the one or more processors, display of an asset listing comprising identifications of one or more assets of the plurality of available assets, the displayed asset listing determined based, at least, on the first data, the second data, and a determination that at least a portion of the first region comprises at least a portion of the second region; and
receiving, by the one or more processors, an indication of a selected asset from the one or more assets of the displayed asset listing.

16. The method of claim 15, further comprising:
causing to transmit, to a supplier associated with the selected asset, a request to obtain use of the selected asset by the recipient; and
receiving an indication of an assent by the supplier associated with the selected asset to the use of the selected asset by the recipient.

17. The method of claim 15, wherein the first region comprises a jobsite of the recipient.

18. The method of claim 15, wherein the second data further comprises a transportation requirement of at least one available asset of the plurality of available assets.

19. The method of claim 15, wherein the second data comprises an indication of a third region associated with at least one available asset from the plurality of available assets, wherein the displayed asset listing is further based on a determination that at least a portion of the third region comprises at least one of at least a portion of the first region and at least a portion of the second region.

20. The method of claim 15, wherein the second data comprises an indication of a third region associated with a third-party support service, wherein the displayed asset listing is further based on a determination that at least a portion of the third region comprises at least one of at least a portion of the first region and at least a portion of the second region.
